(19) United States
(12) Patent Application Publication
(10) Pub. No.: US 2025/0094809 A1
(43) Pub. Date: Mar. 20, 2025

(54) METHOD AND APPARATUS WITH NEURAL NETWORK MODEL TRAINING

(71) Applicants: SAMSUNG ELECTRONICS CO., LTD., Suwon-si (KR); UIF (University Industry Foundation), Yonsei University, Seoul (KR)

(72) Inventors: Minhyuk SEO, Seoul (KR); Hyunseo KOH, Sejong-si (KR); Jonghyun CHOI, Seoul (KR)

(73) Assignees: SAMSUNG ELECTRONICS CO., LTD., Suwon-si (KR); UIF (University Industry Foundation), Yonsei University, Seoul (KR)

(21) Appl. No.: 18/610,995

(22) Filed: Mar. 20, 2024

(30) Foreign Application Priority Data
Sep. 14, 2023 (KR) 10-2023-0122453

(51) Int. Cl. G06N 3/084

(52) U.S. Cl. CPC G06N 3/084

(57) ABSTRACT

A method and apparatus for training a neural network model are provided. The method of training a neural network model includes storing replay samples selected from among online stream samples in a replay buffer, selecting batch samples from the replay samples based on selection frequencies of the respective replay samples, determining a freeze layer group of the neural network model based on forward propagation of the neural network model using the batch samples, and training the neural network model based on backward propagation of layers not in the freeze layer group.

### CROSS-REFERENCE TO RELATED APPLICATIONS

This application claims the benefit under 35 USC § 119(a) of Korean Patent Application No. 10-2023-0122453, filed on Sep. 14, 2023, in the Korean Intellectual Property Office, the entire disclosure of which is incorporated herein by reference for all purposes.

### BACKGROUND

### 1. Field

The following description relates to a method and apparatus with neural network model training.

### 2. Description of Related Art

Technical automation of recognition on new data based on learning from previous data has been implemented using, for example, neural network models implemented by processors (forming a special computation structure). Neural network models provide computationally intuitive mappings between input patterns and output patterns after considerable training. A trained capability of generating mappings may be considered as a learning ability of neural network models. In addition, due to specialized training, specially trained neural networks model may have, for example, a generalization ability to generate relatively accurate outputs for input patterns not specifically trained for.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a training method of training a neural network model is performed by a computing device including storage hardware storing the neural network model and processing hardware, and the training method includes: storing replay samples selected from online stream samples in a replay buffer included in the storage hardware; selecting, by the processing hardware, batch samples from among the replay samples, the selecting based on selection frequencies of the respective replay samples; determining, by the processing hardware, a freeze layer group of the neural network model based on forward propagation of the neural network model using the batch samples; and training, by the processing hardware, the neural network model based on backward propagation of layers of the neural network model that are not in the freeze layer group.

The selection frequencies may correspond to how many times the respective replay samples were previously selected as batch samples, and wherein the higher the selection frequency of a replay sample the less likely the replay is to be selected by the selecting for inclusion in the batch samples.

The training method may further include: determining the selection frequencies of the replay samples based further on similarity scores of the respective replay samples.

The selection frequency of a first replay sample among the replay samples includes a direct component, which increases each time the first replay sample is selected to be used as one of the batch samples, and an indirect component, which increases each time another replay sample among the replay samples is selected to be used as one of the batch samples.

The direct component may increase in proportion to a number of times the first replay sample is selected as a batch sample.

The indirect component may increase in proportion to the number of times another replay sample is selected as a batch sample and a similarity score corresponding to similarity between the first replay sample and the other replay sample.

Each similarity score may be determined based on corresponding output data of the neural network model.

The determining of the freeze layer group may include: estimating an operation amount and an information amount of layers of the neural network model; and determining the freeze layer group based on the operation amount and the information amount.

The estimating of the operation amount and the information amount includes: estimating the operation amount based on a partial operation amount for backward propagation of a first layer to an n-th layer of the neural network model; and estimating the information amount based on a partial information amount of an n+1-th layer to an L-th layer of the neural network model, wherein the “L” is a total number of the layers of the neural network model.

The determining of the freeze layer group may include: determining a value of “n” that maximizes the information amount relative to the operation amount.

The online stream samples may be used for online training of the neural network model.

In another general aspect, an electronic device includes: one or more processors and a memory storing instructions configured to cause the one or more processors to: store, in a replay buffer in the memory, replay samples selected from online stream samples; select batch samples from the replay samples based on selection frequencies of the respective replay samples; determine a freeze layer group of the neural network model based on forward propagation of the neural network model using the batch samples; and train the neural network model based on backward propagation of layers not in the freeze layer group.

The selection frequencies may correspond to how many times the replay samples were previously selected as batch samples, and wherein the higher the selection frequency of a replay sample the less likely the replay is to be selected by the selecting for inclusion in the batch samples.

The instructions may be further configured to cause the one or more processors to: determine the selection frequencies of the replay samples based further on similarity scores of the respective replay samples.

The selection frequency of a first replay sample among the replay samples may be determined based on a direct component, which increases each time the first replay sample is selected to be used as one of the batch samples, and an indirect component, which increases each time another replay sample among the replay samples is selected to be used as one of the batch samples.

The direct component may increase in proportion to a number of times the first replay sample is selected as a batch sample, and the indirect component may increase in proportion to the number of times another replay sample is selected as a batch sample and a similarity score correspond to a similarity between the first replay sample and the other replay sample.

Each similarity score in the similarity information may be determined based on corresponding output data of the neural network model.

In order to determine the freeze layer group, the instructions may be further configured to cause the one or more processors to: estimate an operation amount and an information amount of layers of the neural network model; and determine the freeze layer group based on the operation amount and the information amount.

In yet another general aspect, a method performed by a computing device includes: performing online training of a neural network with a stream of online training samples by: selecting replay samples, from among the online training samples, to be reused for training of the neural network model; maintaining usage statistics of the respective replay samples, including updating the usage statistic of each respective replay sample each time the replay sample is selected for reuse in training the neural network model; and based on the usage statistics, selecting, from among the replay samples, batch samples to be used for training the neural network, and updating the usage statistics of the selected replay samples based on the selection thereof as batch samples.

The updating of the usage statistics may include updating counts of how many times the respective replay samples have been selected as batch samples, and wherein the higher a replay sample's count the less likely the replay sample is to be selected as a batch sample.

Other features and aspects will be apparent from the following detailed description, the drawings, and the claims.

### BRIEF DESCRIPTION OF THE DRAWINGS

FIGS. 1 to 3 illustrate examples of various training methods, according to one or more embodiments.

FIG. 4 illustrates an example of an online continual learning method using a replay buffer, according to one or more embodiments.

FIG. 5 illustrates an example method of training a neural network model, according to one or more embodiments.

FIG. 6 illustrates an example of extracting batch samples from online stream samples, according to one or more embodiments.

FIG. 7 illustrates an example of freezing-based training using batch samples, according to one or more embodiments.

FIG. 8 illustrates an example configuration of an electronic device, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

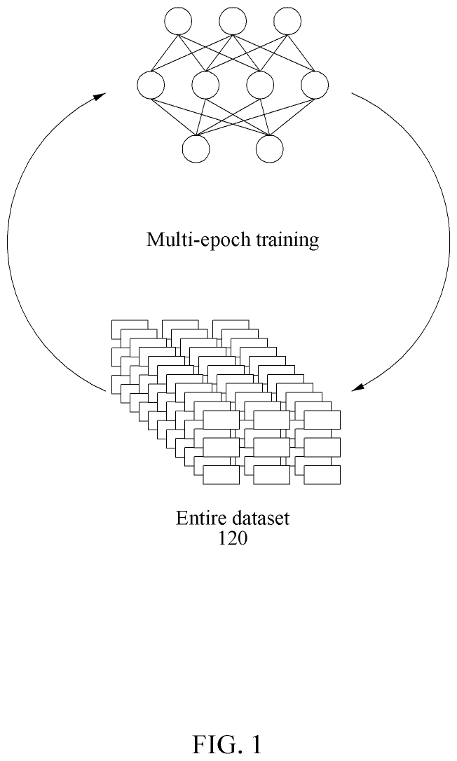

FIGS. 1 to 3 illustrate examples of various learning methods, according to one or more embodiments. Referring to FIG. 1, an entire dataset 120 may be used for training a neural network model 110 over multiple epochs. The entire dataset 120 may include multiple training samples. The learning method shown in FIG. 1 may be referred to as offline standard learning, where training is performed on the neural network model 110 to updates its parameters (e.g., weights) while the neural network model 110 is not in use for performing inferences on non-training data. The neural network model 110 may include multiple layers, including an input layer and an output layer. The input layer may include input nodes that receive input data. The neural network model 110 may also include hidden layers of nodes between the input and output layers. The neural network model 110 may have a network architecture in that each layer's nodes have connections a next layer's nodes (except the output layer). The neural network model 110 may have parameters such as weight, biases, etc. The connections may have the respective weights and the nodes may have the respective biases, for example. The output layer outputs the result of an inference performed by the preceding layers. Details for how a neural network model performs an inference based on an input and the parameters of the neural network model are available elsewhere. In short, the neural network model 110 may be any type of model/architecture that is suitable to have the techniques described herein applied thereto.

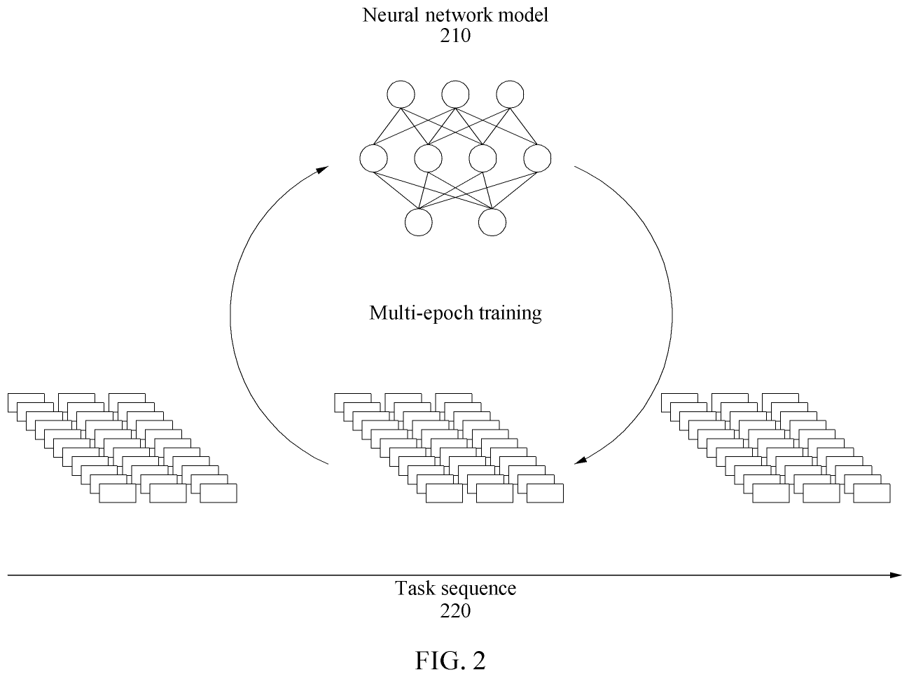

Referring to FIG. 2, a task sequence 220 may be used for training a neural network model 210 over multiple epochs (an epoch being a complete pass through a training set). FIG. 2 shows three tasks, as an example. The tasks may be specific to respective learning goals. Each task in the task sequence 220 may include training samples for its corresponding determined learning goal. The learning method shown in FIG. 2 may be referred to as offline continual learning. To summarize, the offline training shown in FIG. 2 involves training for each task (goal-specific training dataset), one after the other, and the training of each task is performed for multiple epochs.

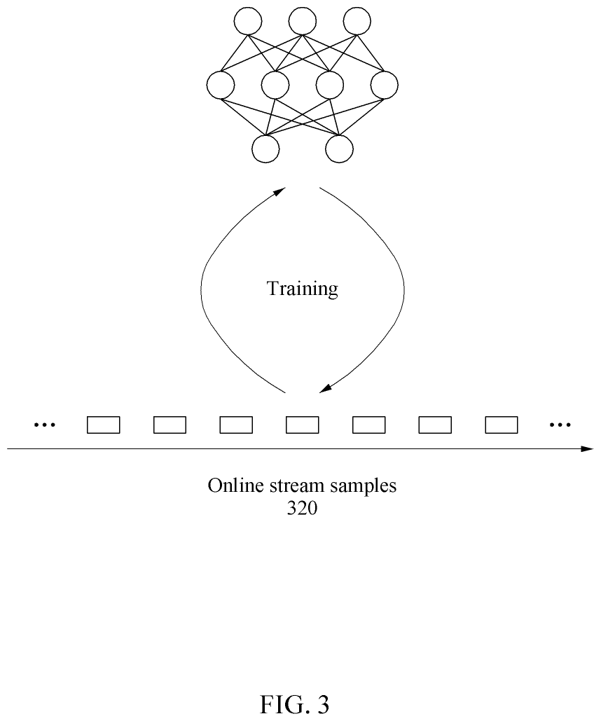

Referring to FIG. 3, online stream samples 320 may be used for training a neural network model 310. Each sample of the online stream samples 320 may be used as a training sample. The learning method shown in FIG. 3 may be referred to as online continual learning.

With offline learning techniques, for example, offline standard learning and offline continual learning, each training sample may be used multiple times over multiple respective epochs. In offline continual learning, unlike offline standard learning, the training samples may be classified by task and form a task sequence (a sequence of samples of respective tasks). For example, each task may have a class configuration (e.g., a classification) that may increase learning efficiency. With online learning, each training sample may be used a limited number of times (e.g., once). Online learning may use less storage space than offline learning.

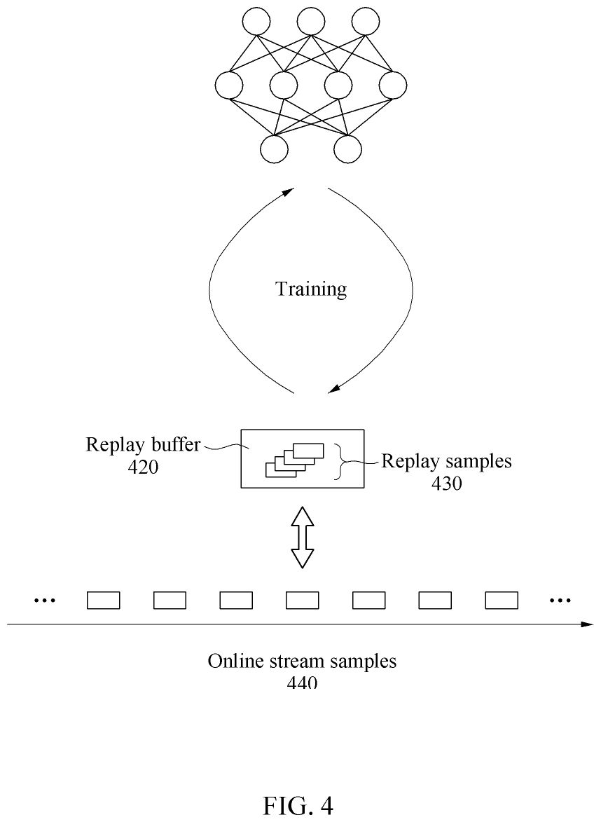

FIG. 4 illustrates an example of an online continual learning method using a replay buffer, according to one or more embodiments. Referring to FIG. 4, online stream samples 440 may be used for training a neural network model 410. The neural network model 410 may be a neural network.

The neural network may be a deep neural network (DNN) that includes multiple layers. The DNN may include at least one of a fully connected network (FCN), a convolutional neural network (CNN), and/or a recurrent neural network (RNN). For example, at least a portion of the layers included in the neural network may correspond to a CNN, and the other portion of the layers may correspond to an FCN. The CNN layers may be referred to as convolutional layers, and the FCN layers may be referred to as fully connected layers.

The neural network may be trained based on deep learning and map input data and output data in a nonlinear relationship to each other to perform inference for the purpose of training. Deep learning is a machine learning technique for solving an issue such as image or speech recognition of a big dataset. Deep learning may be construed as a process of solving an optimization problem, which may be a problem of finding a point at which energy is minimized while training the neural network using prepared training data. Through supervised or unsupervised learning of deep learning, a weight (or other parameter) corresponding to a model or structure of the neural network may be obtained, and the input data and the output data may be mapped to each other through the weight. When the width and depth of the neural network are sufficiently great, the neural network may have a capacity sufficient to implement a determined function. When the neural network is trained with a sufficiently large quantity of training data through an appropriate training process, an optimal inference performance may be achieved.

Each sample of the online stream samples 440 may be a training sample. The learning method shown in FIG. 4 may correspond to online continual learning. A replay buffer 420 may be used in the online continual learning of FIG. 4. The replay buffer 420 may store replay samples 430 selected from among the online stream samples 440. While each training sample may be used a limited number of times (e.g., once), the replay buffer 420 may reduce the limitation (i.e., may increase the number of times buffered samples may be used). Therefore, online learning may be performed using the training sample multiple times while using less storage space compared to offline learning.

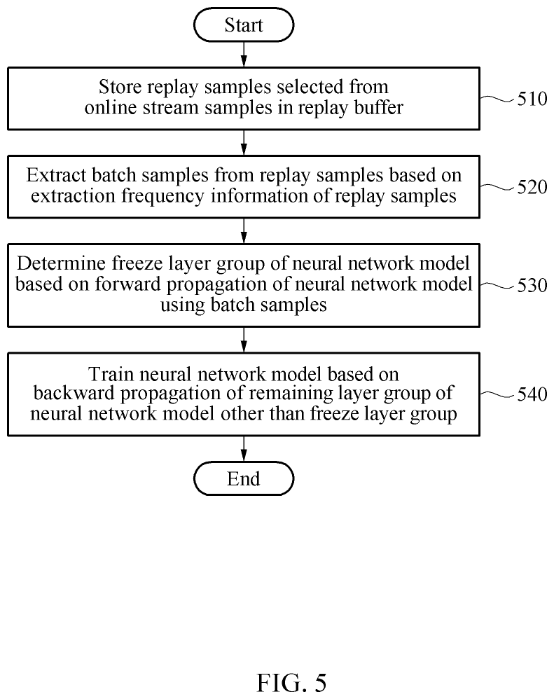

FIG. 5 illustrates an example method of training a neural network model, according to one or more embodiments. Referring to FIG. 5, in operation 510, an electronic device may store replay samples selected from online stream samples in a replay buffer. The buffered replay samples may be selected from among the online stream samples using various methods (described below). For example, random selection, greedy balance selection, or various other methods of selection that may increase learning efficiency and/or learning performance may be used. At least a portion of the replay samples may be replaced in the replay buffer with other online stream samples during a learning process.

In operation 520, the electronic device may, for training, extract batch samples from the replay samples in the replay buffer. Batch samples may be extracted based on extraction frequencies of the replay samples, for example. The extraction frequencies (current values) may be based on previous extraction frequencies of the respective replay samples. Extraction probabilities may be determined for the respective replay samples based on the extraction frequencies. The extraction probabilities may indicate the probabilities that the respective replay samples may be extracted as current batch samples. That is, the extraction probabilities may be used to select which of the replay samples will be included in a training batch. For example, the replay samples having top-N respective extraction probabilities may be selected as the samples to be included in a current batch.

Each replay sample's extraction probability may be set in inverse proportion to its extraction frequency. For example, the replay samples (samples in the replay buffer) may include a first replay sample and a second replay sample. When the first replay sample has an extraction frequency higher than the extraction frequency of the second replay sample, the second replay sample may be given a higher extraction probability than that of the first replay sample. By this approach, the replay samples may be uniformly used for training and the learning efficiency and learning performance may be improved; the more frequently a replay sample is used, the less likely it becomes to be used again.

Next, description of the first replay sample is representative of each of the replay samples.

The electronic device may also determine the extraction frequencies of the respective replay samples based on similarity scores of the respective replay samples. That is to say, each extraction frequency of a corresponding replay sample may be determined based on a direct component (based on a count of actual usages of the corresponding replay sample) and an indirect component (based on counts of actual usages of replay samples similar to the corresponding replay sample). For example, an extraction frequency of the first replay sample may be determined based on (i) the direct (actual usage) component, which increases each time the first replay sample is extracted and used as one of the batch samples, and on (ii) the indirect component, which increases as replay samples similar to the given replay sample are used batch samples. The direct component may increase in proportion to the number of extractions (actual usages as a batch sample) of the first replay sample, and the indirect component may increase in proportion to the number of extractions (actual usages as a batch sample) of respective replay samples similar to the first replay sample (according to the similarity scores).

Similarity scores may indicate class similarities between classes respectively corresponding to the replay samples (or other information, semantic, distance, etc.). The similarity scores may be scores of similarity between classes (possibly multiple classes per replay sample). Each similarity score may be determined based on output data of the neural network model. The neural network model may generate the output data according to inputs of the batch samples extracted from the replay samples. A gradient may be determined based on the difference between the output data and target data. For example, each similarity value in the similarity information may be determined based on the gradient.

Through the direct component and the indirect component, uniform training for each class may be performed and the learning efficiency and learning performance may be improved. For example, if the samples are images, a dog class of a sample image may have high similarity to a cat class sample image and low similarity to an airplane class sample image. When sufficient learning of the dog class has been performed, performing learning of the airplane class may be more desirable than learning of the cat class. When learning of the dog class is performed, extraction frequencies of replay samples of the cat class as well as extraction frequencies of replay samples of the dog class may increase due to an increased indirect component of the extraction frequencies of the replay samples of the cat class. Due to low similarity between the dog class and the airplane class, learning of the dog class may have little effect on extraction frequencies of replay samples of the airplane class. Therefore, learning of a similar group of the dog class and the cat class and learning of the airplane class may be performed in a balanced manner.

In operation 530, the electronic device may determine a freeze layer group of the neural network model based on forward propagation of the neural network model using the batch samples. The electronic device may determine the freeze layer group using operation results from the forward propagation in a state in which backward propagation is not completed.

The electronic device may estimate an operation amount and an information amount of layers of the neural network model and determine the freeze layer group based on the operation amount and the information amount. The electronic device may estimate the operation amount based on a partial operation amount for backward propagation of a first layer to an n-th layer of the neural network model and estimate the information amount based on a partial information amount of an n+1-th layer to an L-th layer of the neural network model. L represents the total number of layers of the neural network model. n may be less than L. The electronic device may, in order to determine the freeze layer group, determine “n” that maximizes the information amount relative to the operation amount.

According to an example, the electronic device may determine the freeze layer group using Equation 1.

$$FIUC ( n ) = \frac{TF}{TF - {\sum }_{i = 1}^{n} {( BF )}_{i}} {{\sum }^{L}}_{i = n + 1} tr ( {F}_{i} ( θ ) ) , \qquad Equation 1$$

In Equation 1, FIUC(n) denotes an information amount of the n-th layer relative to an operation amount of the n-th layer, TF denotes the total operation amount, BF denotes an operation amount of backward propagation, θ denotes a parameter (e.g., a weight), Fᵢ(θ) denotes an information matrix of an i-th layer of the neural network model having the parameter θ, tr(Fᵢ(θ)) denotes an information amount of the i-th layer having the parameter θ, and L denotes the total number of layers of the neural network model.

The information amount of the n-th layer relative to the operation amount of the n-th layer may be referred to as an efficiency level of the n-th layer. TF and BF may indicate the amounts through floating-point operations per second (FLOPS). The information matrix of Fᵢ(θ) may correspond to Fisher information. The information amount of tr(Fᵢ(θ)) may be determined by a trace operation on the information matrix. The electronic device may determine a value of n that maximizes FIUC(n) and thus determine the first layer to the n-th layer as the freeze layer group. In operation 540, the electronic device may train the neural network model based on backward propagation of the remaining (non-frozen) layer group of the neural network model. In a training process of the neural network model, an operation for backward propagation of the freeze layer group may be omitted. Since backward propagation typically requires a greater (e.g., about twice) operation amount than forward propagation, an operation amount for training a model may be significantly reduced by employing the freeze layer group.

As noted, online continual learning may reduce memory usage. High learning efficiency and high learning performance may be achieved through employing the replay buffer and extraction frequencies. Freezing-based training may reduce the operation amount for training. Thus, training method of embodiments herein may indicate high learning efficiency and high learning performance even in an environment with a memory limit and an operation limit, such as a mobile device.

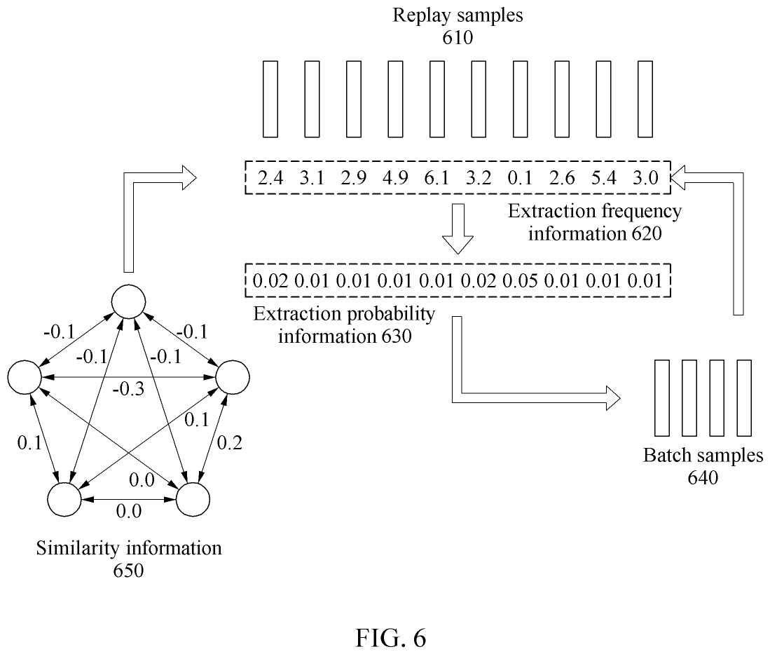

FIG. 6 illustrates an operation of extracting batch samples from online stream samples, according to one or more embodiments. Referring to FIG. 6, batch samples 640 may be extracted from replay samples 610 based on respectively corresponding extraction frequencies 620. Extraction probabilities 630 may be determined based on the respective extraction frequencies 620, and the batch samples 640 may be extracted from among the replay samples 610 based on the extraction probabilities 630. The extraction frequencies 620 may indicate (be based on) previous extraction frequencies of the respective replay samples. The extraction probabilities 630 may indicate the probabilities that each the respective replay samples may be extracted as a current batch sample. Replay samples with, for example, the top-N extraction probabilities may be extracted, i.e., used as batch samples.

The extraction frequencies 620 may be determined based in part on similarity scores 650 of the replay samples. The extraction frequencies value of the respective replay samples 610 may be determined based on a direct component and an indirect component. For example, the replay samples 610 may include a first replay sample. For example, the extraction frequency of the first replay sample may be 2.4. Of that 2.4, a direct amount of 2.0 may be obtained based on the number of times the first replay sample was previously extracted/used (e.g., twice in the example). Of the 2.4, an indirect amount of 0.4 may be obtained according to previous extraction frequencies of respective other replay samples that are similar to the first replay sample. For example, an amount of 0.2 (out of the 0.4 indirection amount) may be obtained when a second replay sample having a similarity score of 0.2 (similarity to the first replay sample) has been previously extracted (used) once, and an amount of 0.2 (out of 0.4 indirect amount) may be obtained when a third replay sample having a similarity score of 0.1 (similarity to the first replay sample) has previously been extracted/used twice. However, these figures are examples and the present disclosure is not limited thereto. To summarize, the extract frequency of a replay sample may be, e.g., a sum of (i) a direct component, which is how many times the replay sample has previously been used as a batch sample and (ii) an indirect component that is a weighted sum of similarity scores of replay samples that are similar to the replay sample (each score weighted by the number of times its corresponding replay sample has previously been extracted/used).

To facilitate selecting replay samples for forming a training batch, the relevant pieces of information (e.g., frequencies/usages, similarity scores of similar replay samples, etc.) may be stored in association with the replay samples, e.g., as an associative array indexed by values of the samples. The information of a sample may be updated via the associative array, for example.

Once a set of batch samples 640 has been formed, training of a neural network model may be performed based on the batch samples 640. The similarity information 650 may be updated based on output of the neural network model. For example, when output data of the neural network model is determined based on the batch samples 640, the similarity scores 650 of the respective batch samples 640 (similarities between each) may be determined based on a gradient according to the output data.

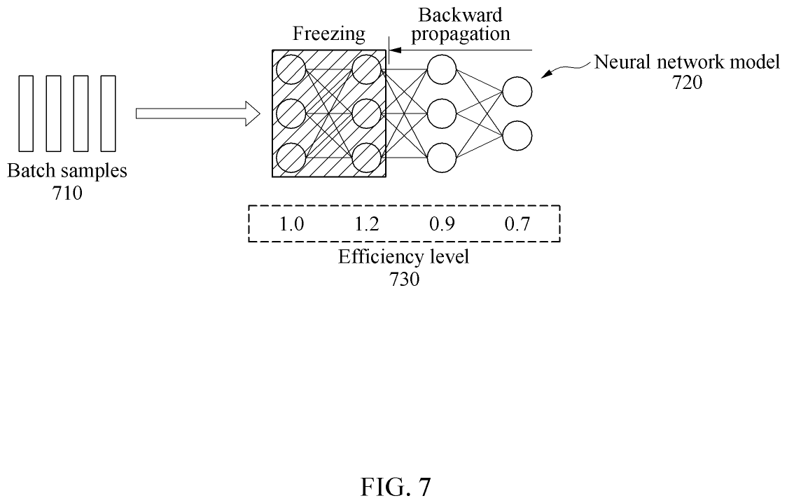

FIG. 7 illustrates an operation of performing freezing-based training using batch samples, according to one or more embodiments. Referring to FIG. 7, a neural network model 720 may be trained based on batch samples 710. The batch samples 710 may be sequentially input to the neural network model 720. The neural network model 720 may be trained based on processing results of the respective batch samples 710 (results of processing by the neural network model 720).

For example, the batch samples 710 may include a first batch sample. Forward propagation of the neural network model 720 may be performed according to the input of the first batch sample, and an efficiency level 730 of each of layers of the neural network model 720 may be determined based on the forward propagation result. For example, a gradient of the last layer may be determined based on the forward propagation, and the efficiency level 730 of each of the layers of the neural network model 720 may be determined based on the gradient of the last layer. The efficiency level 730 of each layer may correspond to an information amount of the layer relative to an operation amount of the layer.

The electronic device may determine a layer that indicates the maximum efficiency level and set up a freeze layer group to include up to that layer. When the maximum-efficiency layer is the n-th layer, the set of layers from the first layer to the n-th layer may be the set as the freeze layer group. The electronic device may perform limited backward propagation on the layer group of non-frozen layers, and train the neural network model 720 based on a result of the backward propagation (e.g., a gradient) in the non-frozen layers, thus focusing learning on the more inefficient layers. Here, the non-frozen layer group may be updated.

For example, as shown in FIG. 7, the efficiency level 730 may be derived as the first batch sample of the batch samples 710 is input to the neural network model 720. In this example, the efficiency level 730 of the second layer is the highest. Accordingly, the first layer and the second layer may be set as the freeze layer group, and the third and fourth layers may be set as the other/non-frozen layer group. Backward propagation may be performed on the third layer and the fourth layer according to the group setting result, and parameters of the third layer and the fourth layer may be updated based on the backward propagation result. Subsequently, a process similar to that of the first batch sample may be repeated by the remaining batch samples of the batch samples 710. Processing of each batch sample may also include updating data of the batch samples, e.g., frequencies/usages, similarity scores, etc.

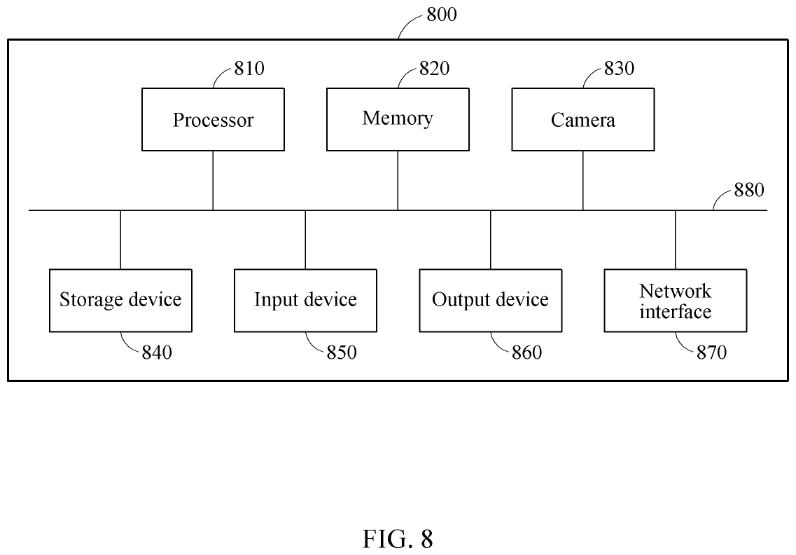

FIG. 8 illustrates an example configuration of an electronic device, according to one or more embodiments. Referring to FIG. 8, an electronic device 800 may include a processor 810 (in practice, one or more individual processors), a memory 820, a camera 830, a storage device 840, an input device 850, an output device 860, and a network interface 870, each of which may communicate with each other through a communication bus 880. For example, the electronic device 800 may be implemented as at least a portion of a mobile device such as a mobile phone, a smartphone, a personal digital assistant (PDA), a netbook, a tablet computer, a laptop computer, and the like, a wearable device such as a smart watch, a smart band, smart glasses, and the like, a home appliance such as a television (TV), a smart TV, a refrigerator, and the like, a security device such as a door lock and the like, and a vehicle such as an autonomous vehicle, a smart vehicle, and the like.

The processor 810 may execute functions and instructions to be executed in the electronic device 800. For example, the processor 810 may process instructions stored in the memory 820 or the storage device 840. The processor 810 may perform the operations described with reference to FIGS. 1 to 7. For example, the processor 810 may store replay samples selected from online stream samples in a replay buffer, extract batch samples from the replay samples based on extraction frequency information of the replay samples, determine a freeze layer group of the neural network model based on forward propagation of the neural network model using the batch samples, and train the neural network model based on backward propagation of the other layer group of the neural network model than the freeze layer group.

The memory 820 may include a computer-readable storage medium or a computer-readable storage device. The memory 820 may store instructions to be executed by the processor 810 and may store related information while software and/or an application is executed by the electronic device 800.

The camera 830 may capture a photo and/or a video, which may serve as a training sample. The storage device 840 may include a computer-readable storage medium or computer-readable storage device. The storage device 840 may store more information than the memory 820 and may store information for a long period of time. For example, the storage device 840 may include a magnetic hard disk, an optical disc, a flash memory, a floppy disk, or other types of non-volatile memory known in the art.

The input device 850 may receive an input from the user in traditional input manners through a keyboard and a mouse and in new input manners such as a touch input, a voice input, and an image input. For example, the input device 850 may include a keyboard, a mouse, a touch screen, a microphone, or any other device that detects the input from the user and transmits the detected input to the electronic device 800. The output device 860 may provide the output of the electronic device 800 to the user through a visual, auditory, or haptic channel. The output device 860 may include, for example, a display, a touch screen, a speaker, a vibration generator, or any other device that provides the output to the user. The network interface 870 may communicate with an external device through a wired or wireless network.

The computing apparatuses, the electronic devices, the processors, the memories, the displays, the information output system and hardware, the storage devices, and other apparatuses, devices, units, modules, and components described herein with respect to FIGS. 1-8 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-8 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A training method of training a neural network model performed by a computing device comprising storage hardware storing the neural network model and processing hardware, the training method comprising:
storing replay samples selected from online stream samples in a replay buffer comprised in the storage hardware;
selecting, by the processing hardware, batch samples from among the replay samples, the selecting based on selection frequencies of the respective replay samples;
determining, by the processing hardware, a freeze layer group of the neural network model based on forward propagation of the neural network model using the batch samples; and
training, by the processing hardware, the neural network model based on backward propagation of layers of the neural network model that are not in the freeze layer group.

2. The training method of claim 1, wherein the selection frequencies correspond to how many times the respective replay samples were previously selected as batch samples, and wherein the higher the selection frequency of a replay sample the less likely the replay is to be selected by the selecting for inclusion in the batch.

3. The training method of claim 1, further comprising:
determining the selection frequencies of the replay samples based further on similarity scores of the respective replay samples.

4. The training method of claim 3, wherein the selection frequency of a first replay sample among the replay samples comprises
a direct component, which increases each time the first replay sample is selected to be used as one of the batch samples, and
an indirect component, which increases each time another replay sample among the replay samples is selected to be used as one of the batch samples.

5. The training method of claim 4, wherein the direct component increases in proportion to a number of times the first replay sample is selected as a batch sample.

6. The training method of claim 4, wherein the indirect component increases in proportion to the number of times another replay sample is selected as a batch sample and a similarity score corresponding to similarity between the first replay sample and the other replay sample.

7. The training method of claim 3, wherein each similarity score is determined based on corresponding output data of the neural network model.

8. The training method of claim 1, wherein the determining of the freeze layer group comprises:
estimating an operation amount and an information amount of layers of the neural network model; and
determining the freeze layer group based on the operation amount and the information amount.

9. The training method of claim 8, wherein the estimating of the operation amount and the information amount comprises:
estimating the operation amount based on a partial operation amount for backward propagation of a first layer to an n-th layer of the neural network model; and
estimating the information amount based on a partial information amount of an n+1-th layer to an L-th layer of the neural network model,
wherein the “L” is a total number of the layers of the neural network model.

10. The training method of claim 9, wherein the determining of the freeze layer group comprises:
determining a value of “n” that maximizes the information amount relative to the operation amount.

11. The training method of claim 1, wherein the online stream samples are used for online training of the neural network model.

12. An electronic device comprising:
one or more processors; and
a memory storing instructions configured to cause the one or more processors to:
store, in a replay buffer in the memory, replay samples selected from online stream samples;
select batch samples from the replay samples based on selection frequencies of the respective replay samples;
determine a freeze layer group of the neural network model based on forward propagation of the neural network model using the batch samples; and
train the neural network model based on backward propagation of layers not in the freeze layer group.

13. The electronic device of claim 12, wherein the selection frequencies correspond to how many times the replay samples were previously selected as batch samples, and wherein the higher the selection frequency of a replay sample the less likely the replay is to be selected by the selecting for inclusion in the batch samples.

14. The electronic device of claim 12, wherein the instructions are further configured to cause the one or more processors to:
determine the selection frequencies of the replay samples based further on similarity scores of the respective replay samples.

15. The electronic device of claim 14, wherein the selection frequency of a first replay sample among the replay samples is determined based on
a direct component, which increases each time the first replay sample is selected to be used as one of the batch samples, and
an indirect component, which increases each time another replay sample among the replay samples is selected to be used as one of the batch samples.

16. The electronic device of claim 15, wherein
the direct component increases in proportion to a number of times the first replay sample is selected as a batch sample, and
the indirect component increases in proportion to the number of times another replay sample is selected as a batch sample and a similarity score correspond to a similarity between the first replay sample and the other replay sample.

17. The electronic device of claim 14, wherein each similarity score in the similarity information is determined based on corresponding output data of the neural network model.

18. The electronic device of claim 12, wherein, in order to determine the freeze layer group, the instructions are further configured to cause the one or more processors to:
estimate an operation amount and an information amount of layers of the neural network model; and
determine the freeze layer group based on the operation amount and the information amount.

19. A method performed by a computing device, the method comprising:
performing online training of a neural network with a stream of online training samples by:
selecting replay samples, from among the online training samples, to be reused for training of the neural network model;
maintaining usage statistics of the respective replay samples, including updating the usage statistic of each respective replay sample each time the replay sample is selected for reuse in training the neural network model; and
based on the usage statistics, selecting, from among the replay samples, batch samples to be used for training the neural network, and updating the usage statistics of the selected replay samples based on the selection thereof as batch samples.

20. The method of claim 19, wherein the updating the usage statistics comprises updating counts of how many times the respective replay samples have been selected as batch samples, and wherein the higher a replay sample's count the less likely the replay sample is to be selected as a batch sample.
